(19) United States
(12) Patent Application Publication
(10) Pub. No.: US 2008/0094711 A1
(43) Pub. Date: Apr. 24, 2008

(54) METHODS AND APPARATUS FOR RECORDING HOLOGRAPHIC GRATINGS

(76) Inventor: Oleg Efimov, Thousand Oaks, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/548,466

(22) Filed: Oct. 11, 2006

(51) Int. Cl. G02B 5/18; G02B 27/44

(52) U.S. Cl. 359/566

(57) ABSTRACT

Methods and apparatus to record large-sized, low frequency holographic gratings by using a two-dimensional scanner with a shearing interferometer.

### BACKGROUND

As is known in the art, there are various conventional systems and methods for creating surface and volume gratings used in a variety of applications. If low-frequency gratings are needed, the hologram recording is carried out with two beams propagating under relatively small angles to each other, especially when the recording wavelength is much shorter than reproducing one. In such a case, existing techniques for recording result in the use of extremely cumbersome setups and/or in significant losses in laser power.

### SUMMARY

The present invention provides method and apparatus to record relatively large-sized low-frequency holographic gratings. A shearing interferometer combined with a two-dimensional scanning apparatus enables the recording of large-sized and low-frequency gratings. While the invention is shown and described in conjunction with particular embodiments and applications, it is understood that the invention is applicable to a variety of application in which it is desirable to create an interference pattern on a target.

In one aspect of the invention, a method comprises scanning a beam of light with a two dimensional scanner to provide an output beam, and directing the output beam to a shearing interferometer having a beamsplitter and a mirror to generate first and second beams for creating an interference pattern on a target by aligning the beamsplitter and the mirror to a predetermined angle.

The method can further include one or more of the following features: wherein the predetermined angle is independent of a distance of the interferometer from the target, the target has a frequency in a range from about 10 to about 100 mm⁻¹, the target has a size of about at least 120 mm×120 mm, blocking a re-reflected beam output from the mirror and reflected by the beamsplitter, forming a grating having ratio of D/Φ larger than about 0.5 mm², where Φ is the spatial frequency, and D is the size of the grating,

In another aspect of the invention, a system comprises a laser, a two dimensional scanner to receive light from the laser and provide an output beam, and a shearing interferometer to receive the output beam from the scanner, the shearing interferometer having a beamsplitter and a mirror to generate first and second beams for creating an interference pattern on a target by aligning the beamsplitter and the mirror to a predetermined angle.

The system can further include one or more of the following features: the predetermined angle is independent of a distance of the interferometer from the target, the target has a frequency in a range from about 10 to about 100 mm⁻¹, the target has a size of about at least 120 mm×120 mm, a blocking mechanism to block a re-reflected beam output from the mirror and reflected by the beamsplitter, and a grating having ratio of D/D larger than about 0.5 mm², where Φ is the spatial frequency, and D is the size of the grating,

### BRIEF DESCRIPTION OF THE DRAWINGS

The exemplary embodiments contained herein will be more fully understood from the following detailed description taken in conjunction with the accompanying drawings, in which:

FIG. 1 is a schematic depiction of a prior art amplitude-splitting interferometer for hologram recording;

FIG. 2 is a schematic depiction of a prior art amplitude-splitting interferometer for low-frequency hologram recording;

FIG. 3 is a schematic diagram of a two-dimensional scanner with a shearing interferometer in accordance with exemplary embodiments of the invention;

FIG. 4 is a schematic diagram showing further details of operation of the interferometer of FIG. 3;

FIG. 5 is a flow diagram showing an exemplary sequence of steps to implement hologram recording in accordance with exemplary embodiments of the invention;

FIG. 6 is a diagrammatical sketch of an interferometer adapted to scan a beam of light in a X-Y plane;

FIG. 6A shows the angular orientation of one of a pair of mirrors in the X-Y plane used in a scanning system of the interferometer of FIG. 6; and

FIG. 6B shows the angular orientation of a second one of the pair of mirrors in the Y-Z plane used in a scanning system of the interferometer of FIG. 6.

### DETAILED DESCRIPTION

Exemplary method and apparatus embodiments of the invention provide for recording relatively large-sized low-frequency holographic gratings. In an exemplary embodiment, a system set up combines a shearing interferometer with a two-dimensional scanning apparatus resulting in the development of a compact, robust, and efficient holographic setup that is useful for recording large-sized and low-frequency gratings. The inventive gratings are useful in a variety of applications, such as low-frequency angularly addressed holographic optical elements for the purpose of angular magnification of beam steering systems. The optical elements should have a small angle of diffraction, high diffraction efficiency, and homogeneity over a large area. Other applications will be readily apparent to one of ordinary skill in the art.

As described in detail below, to satisfy such requirements the recording is carried out with a small angle between the interfering UV beams (e.g., <0.5 degree) with the exposure dosage over a whole area of hologram having a relatively high accuracy (e.g., about 2-3 percent). With regard to an accuracy of exposure dosage, it is understood that exposure dosage is the measure of energy passed through the unit of area, usually measured in J/cm². Thus, it is a measurable value with a concomitant accuracy. Of course, higher accuracy of implementation or irradiation (i.e., smaller deviation of local exposure dosage from average through a whole area) will result in more homogeneous grating.

Before describing the invention in detail, some introductory material is provided. Interference patterns to record surface and volume holograms are typically created with wavefront-splitting interferometers, phase-masks, or amplitude-splitting interferometers.

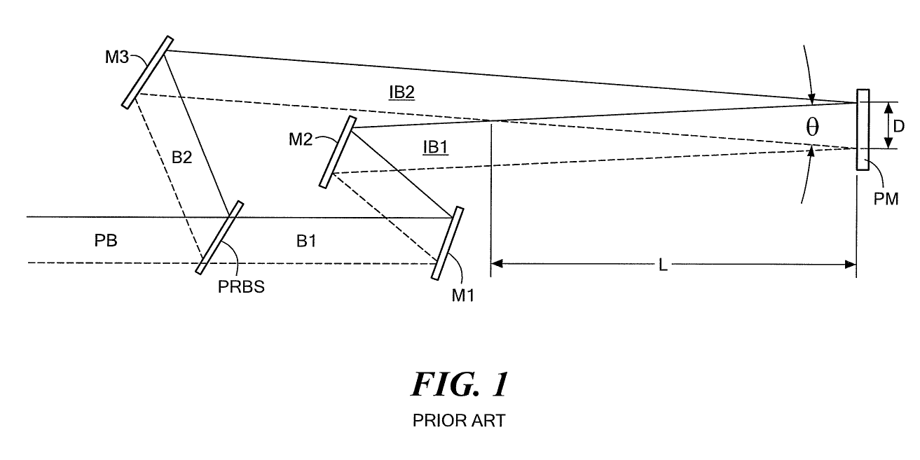

FIG. 1 shows a prior art set up in which first and second interfering beams IB1, IB2 are created by splitting a parent beam PB into first and second beams B1, B2 with a partially-reflecting (p=0.5) beam splitter PRBS. The beams B1, B2 then follow different optical paths via a series of mirrors M1, M2, M3 (ρ=1), after which they are combined on a photosensitive media (a target) PM to record a hologram. An angle θ defines the angular direction of the first and second interfering beams IB1, IB2 in relation to the photosensitive medium PM.

This method has a drawback if both low-frequency and large-sized gratings have to be recorded. It is well known that a spatial frequency Φ of the hologram depends on a recording wavelength λ and on the angle θ0 between the beams as set forth in Equation 1 below:

$$Φ = \frac{2 sin ( \frac{θ}{2} )}{λ} \qquad Eq . ( 1 )$$

### On the other hand, one can see from FIG. 1 that for small angles the relationship in Equation 2 holds:

$$sin ( \frac{θ}{2} ) \approx \frac{D}{2 L} \qquad Eq . ( 2 )$$

where D is the size of grating PM and L is the distance between the interferometer PRBS, M1, M2, M3 and the grating PM. Combining Equations 1 and 2 one finds:

$$L = \frac{D}{λ \cdot Φ} \qquad Eq . ( 3 )$$

Thus, for instance, if the grating in photosensitive glass with a size of 100 mm and a spatial frequency of ˜(10-20)mm⁻¹ is required, the distance between the interferometer and the grating must in the order of ˜(15-30)m for recording at wavelength of ˜0.33 μm. One of ordinary skill in the art will readily appreciate that this relatively long distance complicates the holographic setup.

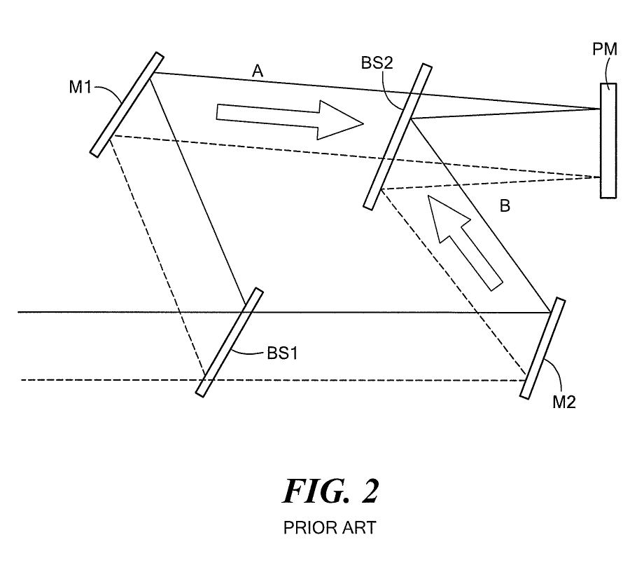

As is also known in the art, setup length can be addressed with the use of an interferometer, such as that shown in the prior art setup of FIG. 2. One of the mirrors M2 in the interferometer set up of FIG. 1 is replaced with a beamsplitter. Therefore, both beams can be combined on the photosensitive medium under a wide range of angles as shown in FIG. 2. However, this scheme results in relatively large losses in exploitable power. If the beamsplitters BS1, BS2, have reflection coefficients ρ1 and ρ2, respectively, the beam powers I_{A}, I_{B}, on the photosensitive medium PM can be expressed in Equation 4:

I_{A}=I₀ρ₁(1−ρ₂)

I_{B}=I₀(1−ρ₁)ρ₂ Eq. (4)

where I₀ is the power of beam incident on the beamsplitter BS1. Taking into account that the beam powers have to be equal for a relatively good grating contrast, one can find that ρ₁=ρ₂. Therefore, the portion of power reaching the medium is

$$\frac{{I}_{A} + {I}_{B}}{{I}_{O}} = 2 ( {ρ}_{0} - {ρ}_{0}^{2} ) \qquad Eq . ( 5 )$$

where ρ₀=ρ₁=₂. This expression has a maximum magnitude of 0.5 at ρ₀=0.5. This means that the total losses in the scheme shown in FIG. 2 are fifty percent or more. Thus, the application of conventional techniques require cumbersome setups and/or result in high losses in laser power.

U.S. patent application Ser. No. 11/281,034, filed on Nov. 17, 2005, which is incorporated herein by reference, and which has the same inventor and assignee, describes one exemplary set up using two-dimensional scanning of small-sized beam over the area of a standard interferometer like that shown in FIG. 1.

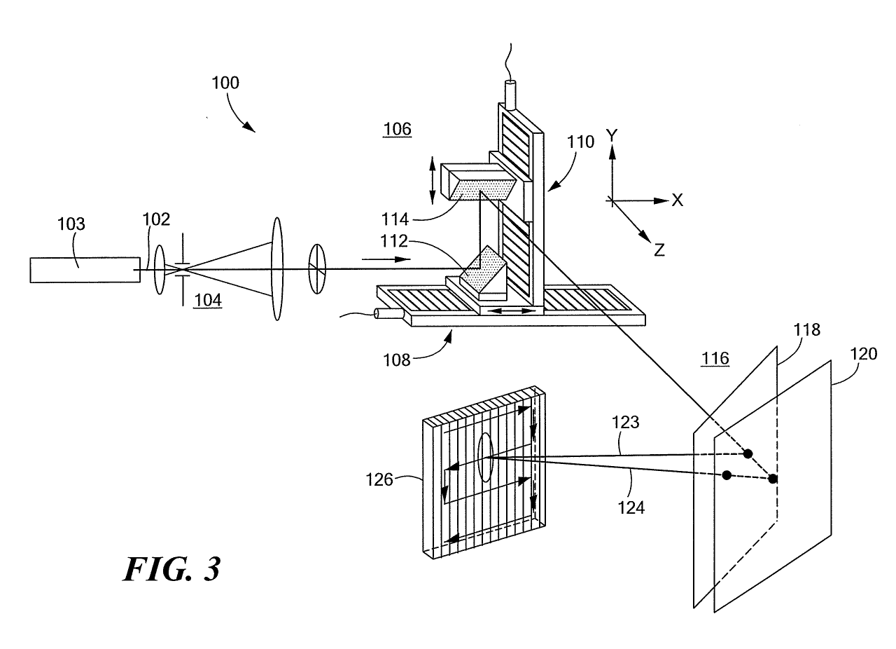

FIG. 3 shows an exemplary system 100 having a two-dimensional scanner with a shearing interferometer for recording large-sized low-frequency gratings. It is understood that the terms large-sized and low-frequency are dependent to each other. The length L can be about 1-2 m as the typical length of a standard optical table is of about 3 m. Setting the length L to 1.5 m, the laser wavelength for grating recording in photosensitive glass is of about 0.33 μm. Then from Eq. (3):

$$\frac{D [ mm ]}{Φ [ {mm}^{- 1} ]} = λ \cdot L = 1500 mm \cdot 0.00033 mm \approx 0.5 {mm}^{2}$$

Thus, if the ratio of D/Φ is larger than about 0.5, one can say that a grating is large-sized and low-frequency. Usually, the sizes of gratings of 50 mm and more are considered to be large-sized. Therefore, the spatial frequencies of gratings of 25 mm⁻¹ and less can be considered as low frequencies. However, for a grating with a size of ˜100 mm, even a frequency of 50 mm⁻¹ is low frequency as it follows from the above-mentioned equation.

A beam 102 from a laser is cleaned of spatial noise with a spatial filter 104 that simultaneously expands the beam to the desired size. The processed beam passes a scanning system 106 having a first and second translation stages 108, 110 with first and second mirrors 112, 114. The beam is then directed into a shearing interferometer 116 formed of a beam splitter 118 and a total mirror 120 placed relatively close to each other. The laser beam is split in the interferometer 116 into first and second beams 122, 124 which create an interference pattern by overlapping on a target 126, such as a photosensitive medium.

The scanning system 106 provides two-dimensional scanning of a beam over the cross section area of the interferometer 116 and exposure of the target 126 with the interference pattern. One can see that regardless of the distance between the target 126 and the interferometer 116, the angle between interfering beams 122, 124 can be made quite small by the proper alignment of the beamsplitter 118 and/or the mirror 120. On the other hand, this scheme conserves more power than conventional set ups, such as the arrangement of FIG. 2. If the beamsplitter 118 has the reflection coefficient of ρ, one can calculate the powers I_{A}, I_{B} of the interfering beams:

I_{A}=I₀ρ

I_{B}=I₀(1−ρ)₂ Eq. (6)

where I₀ is the power of the beam incident on interferometer. The beam powers should be equal for a good grating contrast, as was mentioned previously:

I_{A}=I_{B}

ρ=(1−ρ)² Eq. (7)

From the above, one can find the value of ρ (0.382) and calculate the total losses:

$$γ = 1 - \frac{{I}_{A} + {I}_{B}}{{I}_{0}} = 0.236 \qquad Eq . ( 10 )$$

Thus, it can be seen that the total losses in this case (23.6%) are more than two times less than in the conventional set up of FIG. 2. The inventive methods and apparatus provide relatively compact and power conserving setups.

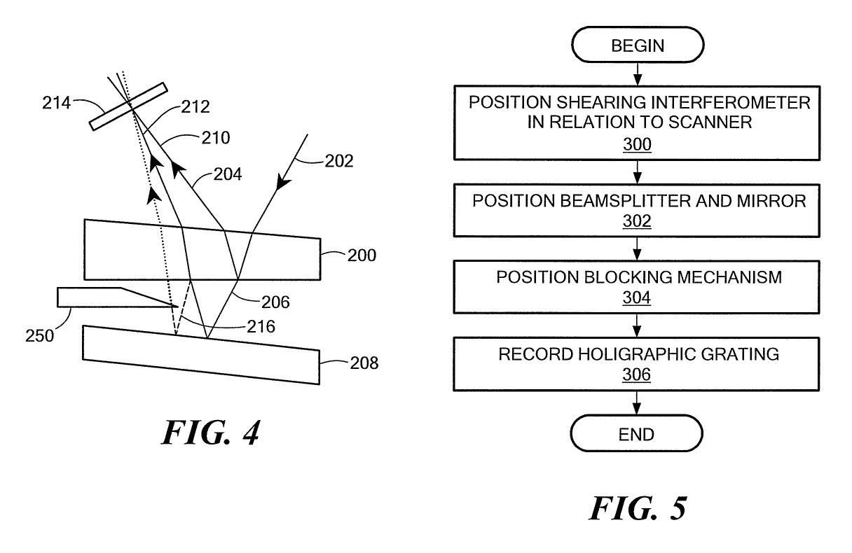

The usage of shearing interferometer results in multiple beam outputs from the interferometer and in multiple grating recording. One can estimate that the first re-reflected beam shown by dash line in FIG. 4 has the power of about thirty-eight percent of beam power I_{A} or I_{B}.

FIG. 4 shows the influence of re-reflected beams of the recording process from the interfering beams. The beamsplitter 200 splits the first beam 202 into first and second beams 204, 206. The second beam 206 is reflected by the mirror 208 back into the beamsplitter 200 to provide interfering beams 210, 212 on the target 214. However, a re-reflected beam 216 results from the beam from the mirror striking the beamsplitter 200 and reflecting back to the mirror 208.

The power of the re-reflected beam 216 is comparable with the powers of basic beams and may result in significant parasitic grating recording. In the case of large-sized beam it may not be possible to remove the parasitic grating recording entirely. However, the inventive scanning techniques allow the use of a small-sized beam for exposure and shows the way to overcome this obstacle. In the case of a relatively small-sized beam, the re-reflected beams can be blocked with an optical knife 250, for example. In one embodiment, the knife 250 is moved synchronously with the first scanning translation, such as the first stage 112 of FIG. 3, if large-sized grating recoding is needed.

It is understood that a variety of mechanisms can be used to block the re-reflected beam. While shown as a ‘knife’, one of ordinary skill in the art will recognize that any suitably configured device formed from a light-blocking material can block the beam. In addition, while shown as a mechanical device, it is contemplated that interference or polarization concepts may be used to block or otherwise attenuate the re-reflected beam.

FIG. 5 shows an exemplary sequence of steps to record large-sized, low frequency holographic gratings in accordance with exemplary embodiments of the invention. In step 300, a shearing interferometer is positioned in relation to a two-dimensional scanning system. In step 302, the beamsplitter and mirror of the interferometer are placed in a desired angle with respect to each other in relation to a target in which the hologram will be recorded. In optional step 304, a blocking mechanism is positioned to block re-reflected beams from the mirror to minimize parasitic recording on the grating. The blocking mechanism is moved synchronously with the scanning translation for larger-sized gratings. In step 306, the hologram (or holographic grating. Please, correct it in FIG. 5) is recorded.

The inventive methods and apparatus are advantageous to both large-sized and low-frequency grating recording. For example, the following advantages can be provided:
Uniformity of exposure. The uniformity of exposure is provided by a proper scanning pattern of Gaussian beams across the target area.
Parasitic Diffraction Patterns Exclusion. A large beam expansion required for large-sized grating recording is hard to implement without truncating its edges which results in imprinting parasitic diffraction patterns into the gratings. In the inventive methods and apparatus the size of recording beam is considerably smaller than the size of hologram, therefore, scanning can be done so as to exclude any truncating the beam edges.
Mitigating Distortions and Optical Inhomogeneities. One of the advantages of the inventive scanning techniques is that they allow recording well-characterized gratings even if the recording beam wavefronts are not in perfect plane and/or if they have small local distortions. As described in the '034 application, imperfections of the beams are reduced dramatically during the scanning and they influence only the contrast of grating and the width of fringes.

### EXAMPLE

To demonstrate advantages of the inventive methods and apparatus, a compact setup was developed to record the low-frequency (10-100 mm⁻¹) gratings with size up to 125 mm×125 mm. A single-line (334.5 nm) Ar-ion laser (Innova 400, Coherent, Inc., www.cohr.com) was used to produce a nearly Gaussian beam with less than 2 mm diameter. It was cleaned of spatial noise, expanded up to the diameter of 10 mm at 1/e² of maximum, and sent into a scanner. The scanner included two computer controlled translation stages UTMCC1DD (Newport Corporation, USA, www.newport.com) as shown in FIG. 3. These stages secured the direction of scanning beam with accuracy of ˜10⁻⁴ rad. This value was sufficiently small for high quality hologram recording. Then, the beam from the scanner was directed to the interferometer formed of a beamsplitter with size of 125 mm×225 mm and reflection coefficient of 38.2 percent and a total mirror with size of 125 mm×125 mm. The distance between the interferometer and to vary the angle between interfering beams, i.e., the spatial frequency of gratings. An optical knife was placed between the beamsplitter and total mirror to block re-reflected beams and it was moved synchronously with the scanner with a proper speed.

This setup was used to record thick Bragg gratings in a photosensitive glass from Corning, Inc. (www.corning.com). The procedure for glass exposure and thermal development will be readily apparent to one of ordinary skill in the art. For example, an exemplary procedure is described in O. M. Efimov, et al, “High-efficiency Bragg Gratings in photothermorefractive glass,” Appl. Optics, Optical Technology and Biomedical Optics (OT&BO), 38, 619-627 (1999), which is incorporated herein by reference. The grating with size of 100 mm×100 mm, thickness of 3.5 mm, and angle of beam diffraction of 80 was optimized for a wavelength of 1550 nm. A collimated beam of ˜150 mm diameter was used to measure the absolute diffraction efficiency of the grating. The diffraction efficiency of 94% was demonstrated for the grating. The optical inhomogeneities presented in the volume of original glass had not allowed reaching the higher diffraction efficiency.

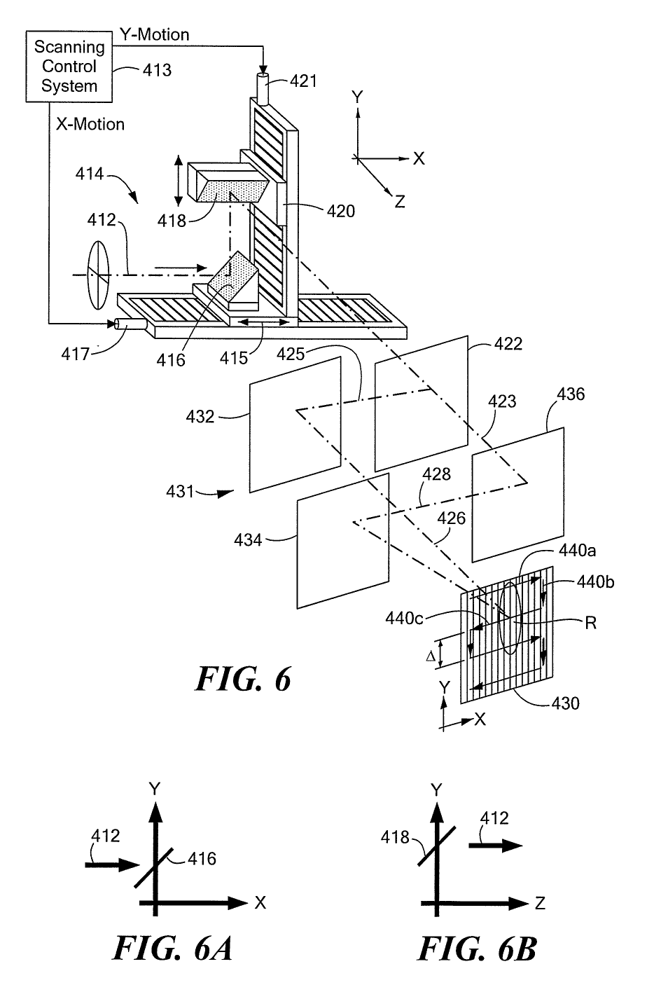

The scanner 106 of FIG. 3 is shown in FIG. 6 and discussed in further detail below. An exemplary interferometer is shown for recording large-sized high-homogeneous holographic diffraction gratings. It is noted that two-dimensional or three-dimensional (i.e., Bragg) diffraction grating may be recorded.

Light from a laser, not shown, is cleaned from spatial noises and is then expanded in cross sectional area to a proper size, using any standard optical system having a beam expander, not shown, and a spatial filter, not shown, to produce an input beam of light 412. The cross sectional area of the input beam 412 has a Gaussian amplitude distribution and such input beam 412 has a substantially planar wavefront.

The input beam passes to a scanning system 414. The scanning system scans the input beam in two dimensions. Thus, if the input beam 412 passes along an X-axis, the output beam is scanned in the X-Y plane.

More particularly, here, for example, the scanning system has a first structure, here a translation stage 415. The structure 415 has mounted to a pair of mirrors 416, 418. Mirror 416 has a reflecting surface tilted 45 degrees about the X and Y axes, as shown in FIG. 6A and mirror 418 has a reflecting surface tilted 45 degrees about the Y and Z axes, as shown in FIG. 6B. Further, the structure 415 is arranged to move back and forth along the X-axis by a motor 417 that drives a screw, not shown, in response to a signal from a scanning control system 413, such X-axis motion thereby scans the input beam 412 back and forth along the X-axis. It is noted that mirror 418, while mounted to structure 415 is also mounted to a structure 420 here also a translation stage. The structure 420, which is mounted to structure 415 is configured to move within structure 415 up and down along the Y-axis by a motor 421 that drives a screw, not shown, in response to a signal from a scanning control system 413. Thus, for any position of the structure 415 along the X-axis, the structure 420 is able to scan the input beam up and down along the Y-axis. It follows then that movement of both the structure 415 and the structure 420 results in scanning of the input beam 412 in two dimensions, here in the X-Y plane.

Next, the scanned input beam 412 is directed in a beam splitter 422 to provide a pair of output beams 423, 425 directed along different paths 426, 428, respectively, to common region R on a surface of a recording medium 430. The recording medium 430 records a diffraction grating generated by interference between the two output beams of light. The two output beams of light maintain a substantially constant cross section here having a substantially Gaussian amplitude distribution as such beams pass to the common region R on the recording medium. Thus, the two output beams of light 423, 425 maintain a substantially constant cross section between the beam splitter 422 and the recording medium 430.

More particularly, the scanned input beam is directed to four mirrors, i.e., beam splitter 422 and an optical system 431 having mirrors 432, 434, and 436 for directing each one of the two output beams of light along a different path to the common region R on the recording medium 430. The region R is scanned in a two dimensional surface, i.e., in the X-Y plane of the recording medium 430 during the scanning of the input beam of light as indicated by the arrows 440. Here, in this example, at a first position of mirror 418 along the Y-axis, the structure 415 moves along the +X axis to produce a scan indicated by arrow 440a. Next, the structure 420 lowers mirror 418 along the Y-axis with the position of structure 415 fixed to produce a vertical scan along the Y-axis indicated by vertical arrow 440b. It is noted that the length of the scan along the Y-axis indicated by vertical arrow 440b is herein sometimes referred to as the beam shift Δ. The beam shift Δ should be less than 0.4 to 0.45 times the diameter of the Gaussian beam used for a scanning good homogeneity of exposure dosage.

Next, with the structure 420 fixed along the Y-axis, the structure 415 moves along the −X axis to produce the scan indicated by arrow 440c and the process repeats with the structure 420 lowering mirror 418 as indicated. Thus, scanning system 414 provides two-dimensional scanning of beam over the cross section area of the recording medium 430 and exposure of the target area on such medium 430 with the interference pattern. Here, computer controlled translation stages UTMCC1DD manufactured by Newport Corporation, USA and having the angular accuracy of 10⁻⁴ radians were used.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method, comprising:
scanning a beam of light with a two dimensional scanner to provide an output beam;
directing the output beam to a shearing interferometer having a beamsplitter and a mirror to generate first and second beams for creating an interference pattern on a target by aligning the beamsplitter and the mirror to a predetermined angle.

2. The method according to claim 1, wherein the predetermined angle is independent of a distance of the interferometer from the target.

3. The method according to claim 1, wherein the target has a frequency in a range from about 10 to about 100 mm⁻¹.

4. The method according to claim 1, wherein target has a size of about at least 120 mm×120 mm.

5. The method according to claim 1, further including blocking a re-reflected beam output from the mirror and reflected by the beamsplitter.

6. The method according to claim 1, further including forming a grating having ratio of D/Φ larger than about 0.5 mm², where Φ is the spatial frequency, and D is the size of the grating.

7. A grating formed by the method of claim 1.

8. A system, comprising:
a laser;
a two dimensional scanner to receive light from the laser and provide an output beam;
a shearing interferometer to receive the output beam from the scanner, the shearing interferometer having a beamsplitter and a mirror to generate first and second beams for creating an interference pattern on a target by aligning the beamsplitter and the mirror to a predetermined angle.

9. The system according to claim 8, wherein the predetermined angle is independent of a distance of the interferometer from the target.

10. The system according to claim 9, wherein the target has a frequency in a range from about 10 to about 100 mm⁻¹.

11. The system according to claim 8, wherein target has a size of about at least 120 mm×120 mm.

12. The system according to claim 8, further including a blocking mechanism to block a re-reflected beam output from the mirror and reflected by the beamsplitter.

13. The system according to claim 8, further including a grating having ratio of D/Φ larger than about 0.5 mm², where Φ is the spatial frequency, and D is the size of the grating.
